(19) United States
(12) Patent Application Publication
(10) Pub. No.: US 2025/0117230 A1
(43) Pub. Date: Apr. 10, 2025

(54) System And Method For Recording User Actions And Resubmitting User Actions For A Graphical User Interface

(71) Applicant: Oracle International Corporation, Redwood Shores, CA (US)

(72) Inventors: Shrikanth Narayanaswamy Chandrasekaran, Tamil Nadu (IN); Joseph Alexander Levy, Seattle, WA (US); Jyoti Saini, Redmond, WA (US); Shreya Krishnan, Austin, TX (US)

(73) Assignee: Oracle International Corporation, Redwood Shores, CA (US)

(21) Appl. No.: 18/484,175

(22) Filed: Oct. 10, 2023

(51) Int. Cl. G06F 9/451

(52) U.S. Cl. CPC G06F 9/451

(57) ABSTRACT

Techniques for recording submissions of a user actions in relation to interface elements of a GUI for replay are disclosed. Data arguments generated in response to the user actions required for executing a command associated with the user actions are recorded. A system monitors execution of an application. The system detects a command or action that corresponds to submission of a user action in relation to target interface elements displayed by a GUI. When the system detects the command, the system records the user action in relation to the target interface element and data arguments selected for executing the command. When the system receives a request to replay the submission of the user action, the system retrieves the data arguments for executing the command and causes execution of the command by submitting the user action to the GUI along with the data arguments for executing the command.

### TECHNICAL FIELD

The present disclosure relates to systems and methods of improving developer experience. In particular, the present disclosure relates to systems and methods for recording user actions along with data input for replay.

### BACKGROUND

During software development, software engineers may perform a similar set of tasks (actions or commands) repeatedly within a software application. Executing each of these tasks or workflows may include performing many sub-tasks. These sub-task may include traversing a tree view, navigating menu options, locating an item, entering text into multiple fields, providing data arguments, and copying and pasting artifacts. Every time the software engineer desires to perform a particular task, the user must reperform all the sub-tasks prior to being able to execute the particular task. The repetitive process of reperforming all the sub-tasks is time consuming and inefficient, and may be subject to error.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a software and/or hardware system in accordance with one or more embodiments;

FIGS. 7A and 7B illustrate an example set of operations for recording user actions in accordance with one or more embodiments;

FIGS. 8A-8E illustrate an example of recording a user action and data arguments associated with the user action for replay; and

FIG. 9 illustrates another example of recording a user action and data arguments for replay.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. CLOUD COMPUTING TECHNOLOGY
3. COMPUTER SYSTEM
4. REPLAY SYSTEM ARCHITECTURE
5. RECORDING USER ACTIONS AND DATA ARGUMENTS FOR REPLAY
6. EXAMPLE EMBODIMENTS
7. MISCELLANEOUS; EXTENSIONS

### 1. General Overview

One or more embodiments record and resubmit a user action in relation to an interface element with a Graphical User Interface (GUI), with a corresponding data argument. Recording and resubmitting the user action with corresponding data arguments results in execution of a command. The system improves user experience and productivity by reducing the number of user actions that have to performed by users for execution of commands.

Initially, a system monitors execution of an application, including user actions received by the application. The system detects a command or action that corresponds to submission of a user action in relation to target interface elements displayed by a GUI. When the system detects the command, the system records (a) the user action in relation to the target interface element that triggered the command and (b) the data arguments used for executing the command. When the system receives a request to replay the submission of the user action (e.g., from a menu of recorded actions), the system retrieves the data arguments for executing the command and causes execution of the command by submitting the user action to the GUI along with the data arguments for executing the command.

One or more embodiments cause execution of a command by identifying system features that enable successful execution of the command and configuring the identified system features to enable successful execution of the command. The system features that enable successful execution of a command may correspond to display and/or configuration of particular elements of an interface that are needed to enable successful submission of the user action that triggers the command. The system features that enable successful execution of a command may correspond to back-end features such as instantiation of a type (e.g., a Java class) to generate an object that is needed to execute the command.

One or more embodiments selectively record user actions in relation to user interface elements, along with corresponding data arguments, for replaying the submission of the user actions. The system selectively records when the system determines that a recordation criteria is met based on attributes associated with the user action, the data arguments, the command, a user profile, and/or an execution environment.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In some cases, a cloud computing model will involve the participation of a cloud provider. The cloud provider may, but need not be, a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

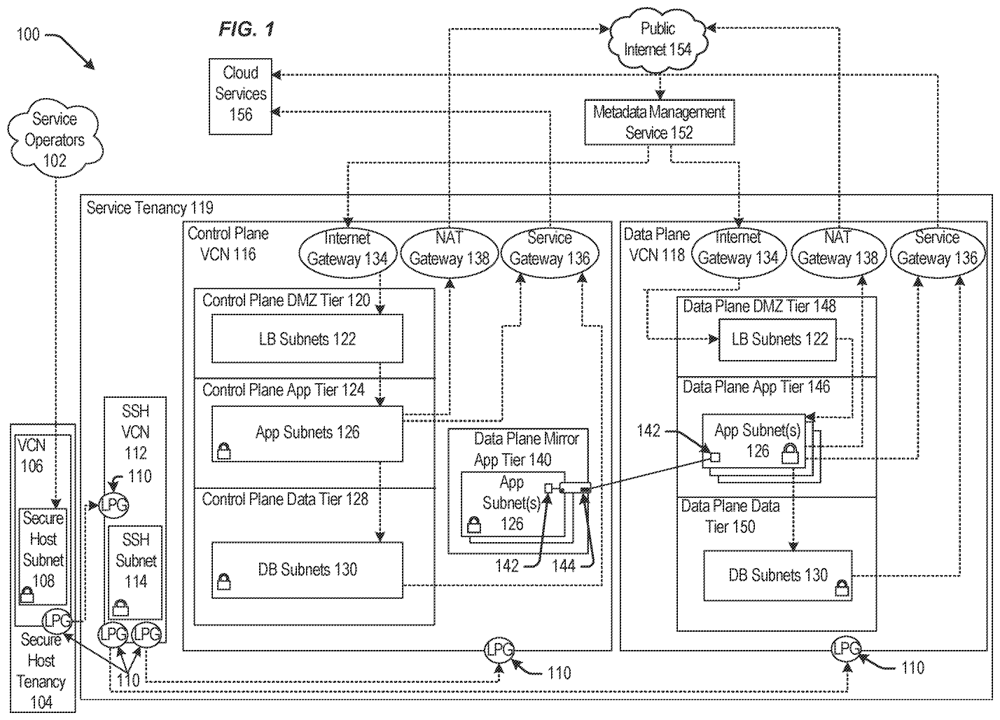

FIG. 1 is a block diagram 100 illustrating an example pattern of an IaaS architecture, according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119, which may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154, which may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119, which may be isolated from public Internet 154.

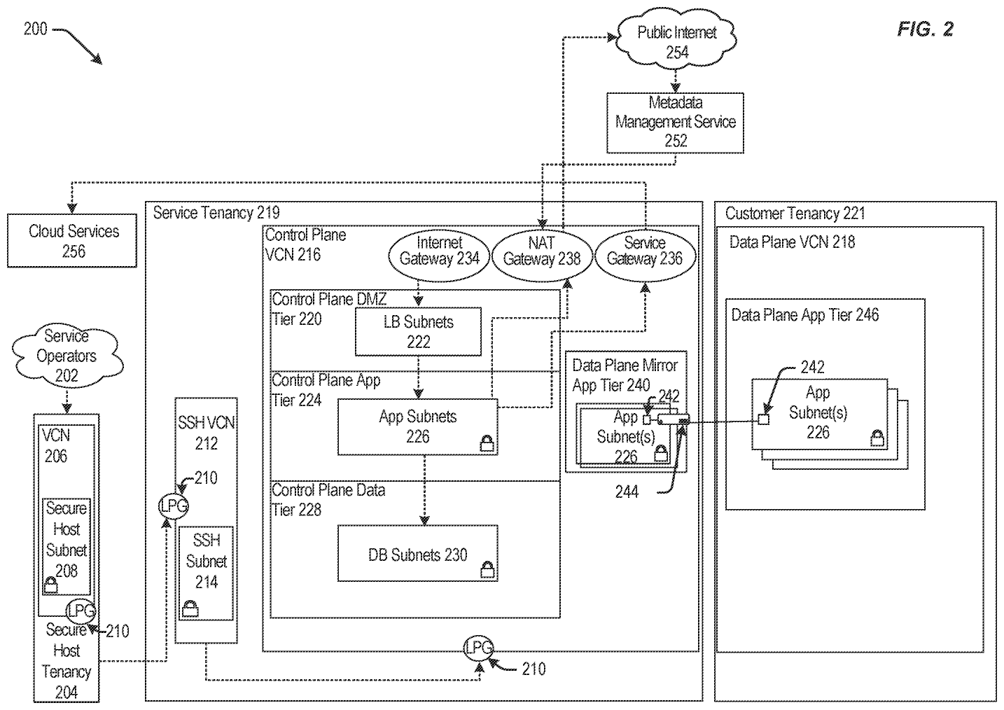

FIG. 2 is a block diagram 200 illustrating another example pattern of an IaaS architecture, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

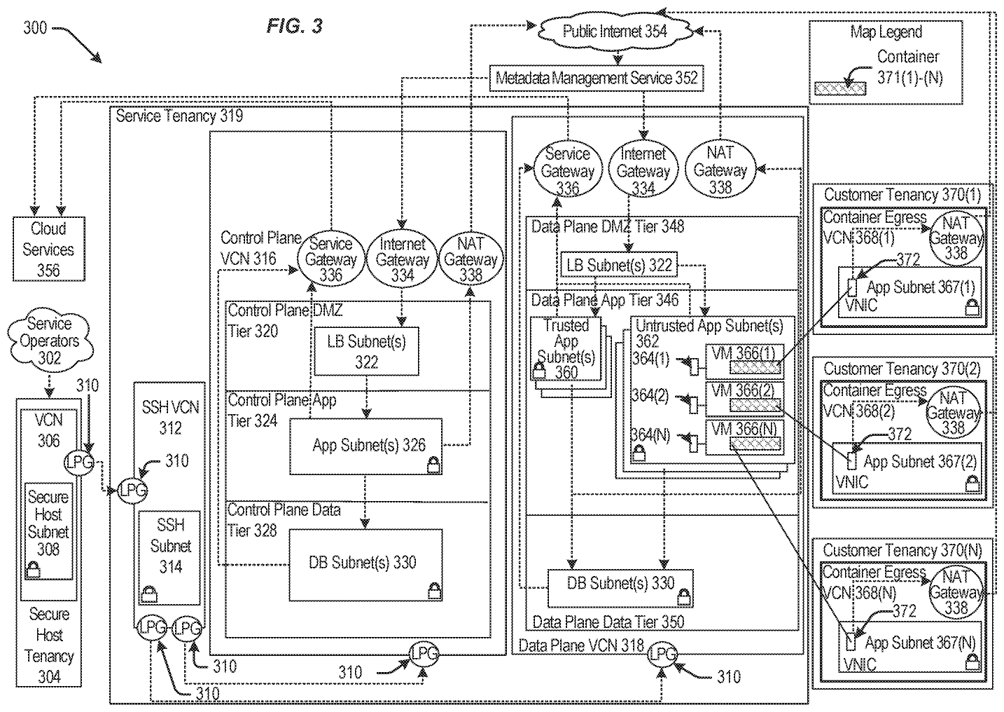

FIG. 3 is a block diagram 300 illustrating another example pattern of an IaaS architecture, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 370(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management system 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 370. Respective containers 371(1)-(N) contained in the VMs 366(1)-(N) may be configured to run the code. In this case, there can be a dual isolation (e.g., the containers 371(1)-(N) running code, where the containers 371(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 371(1)-(N) may be communicatively coupled to the customer tenancy 370 and may be configured to transmit or receive data from the customer tenancy 370. The containers 371(1)-(N) may not be configured to transmit or receive data from any other entity in the data plane VCN 318. Upon completion of running the code, the IaaS provider may kill or otherwise dispose of the containers 371(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 371(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

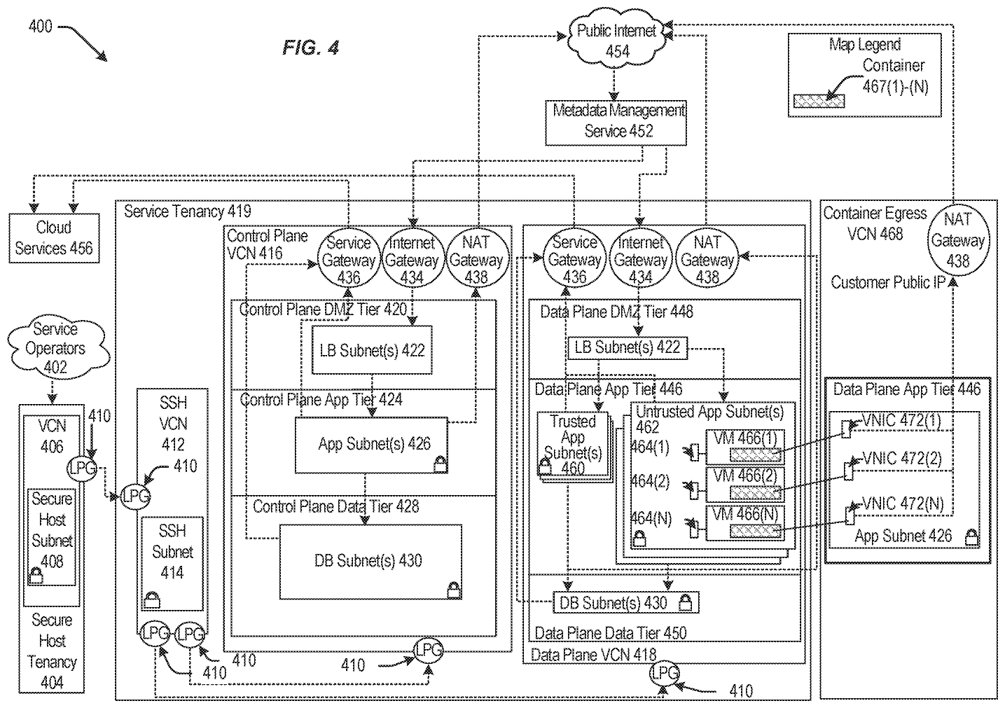

FIG. 4 is a block diagram 400 illustrating another example pattern of an IaaS architecture, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can P a e 16 include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management system 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. Computer System

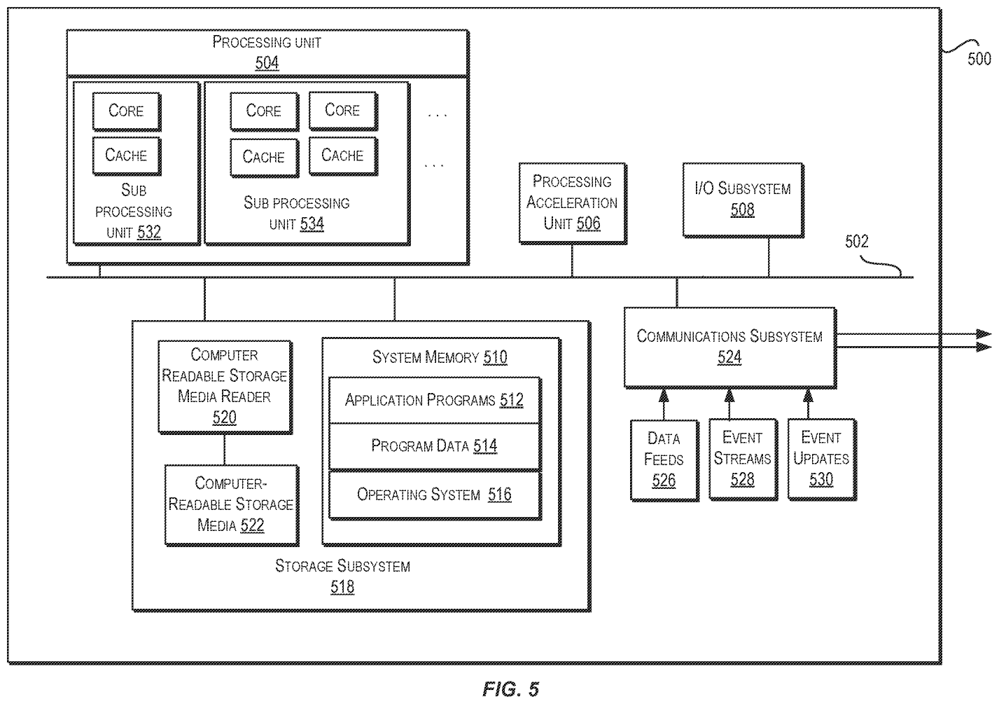

FIG. 5 illustrates an example computer system 500, in which various embodiments may be implemented. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions that are loadable and executable by processing unit 504. System memory 510 may also store data that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500, such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Replay System Architecture

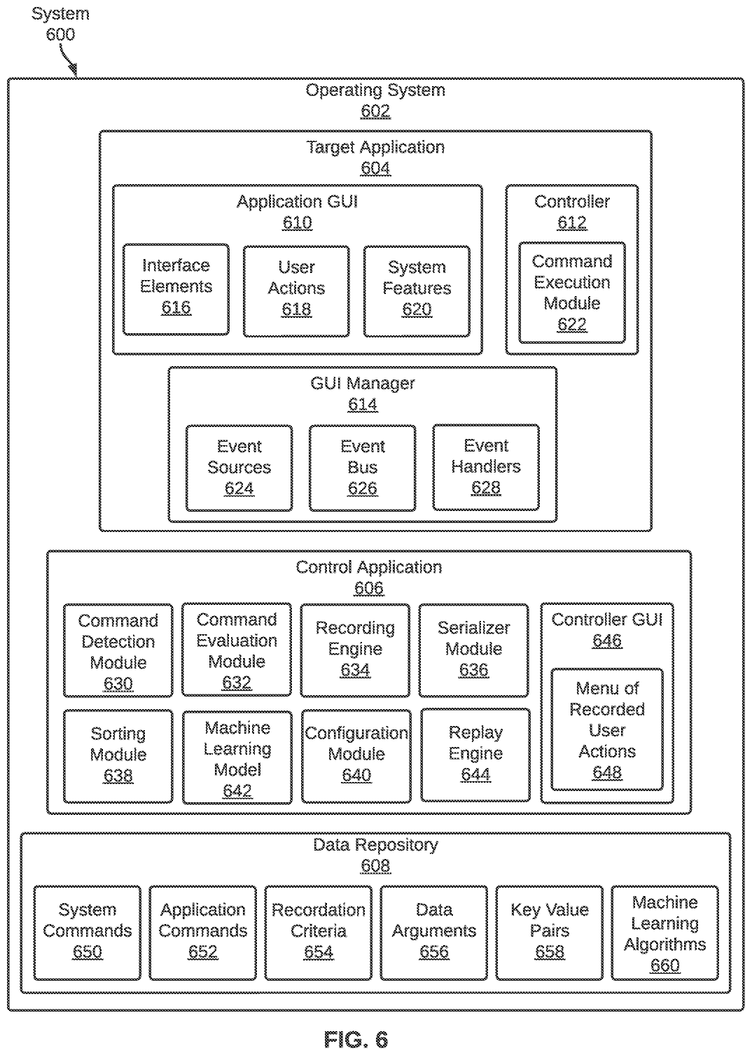

FIG. 6 illustrates a system 600 in accordance with one or more embodiments. As illustrated in FIG. 6, the system 600 includes an operating system 602, a target application 604, and a control application 606. In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described above in Section 2, titled “Cloud Computing Technology”.

In one or more embodiments, the operating system 602 is software that manages computer hardware and software resources and provides common services for the target application 604 and the control application 606. The operating system 602 provides a layer of abstraction between hardware and software and manages the execution of programs. When a user starts an application, e.g., target application 604 or control application 606, the operating system 602 loads the application into memory and begins running the application. The operating system 602 tracks the programs running on the system 600, and ensures that the applications do not interfere with each other. The operating system 602 provides an interface for users to interact with the computer. The user interface allows users to control the computer by issuing commands or by clicking on graphical elements. Examples of operating systems include Windows, macOS, Linux, and Android.

In one or more embodiments, the target application 604 is a software program that utilizes a Graphical User Interface (GUI) to allow users to interact with the computer or device. The target application 604 presents visual elements for users to interact with and navigate the software. GUI applications are prevalent in various domains, including desktop software, web applications, and mobile apps. The target application 604 may display various types of media and content, including images, videos, graphs, and charts. Examples of target applications 604 include word processors (Microsoft Word, Google Docs), spreadsheet software (Microsoft Excel, Google Sheets), web browsers (Chrome, Firefox), image editors (Adobe Photoshop), video players (VLC Media Player), and integrated development environments (IDE) (Eclipse, Visual Studio, Xcode, IntelliJ IDEA, NetBeans).

In one or more embodiments, the target application 604 is an integrated development environment (IDE). The IDE is a comprehensive software application that provides a set of tools and features for streamlining and enhancing the process of software development. The IDE combines several components and functionalities into a single, unified environment, for developers to create, edit, debug, and manage software projects. Example IDEs include, Visual Studio (for various languages, including C#, Python, and JavaScript), Eclipse (primarily for Java, but extensible for other languages), IntelliJ IDEA (for Java, Kotlin, and other JVM languages), PyCharm (for Python), Xcode (for iOS and macOS development), Android Studio (for Android app development), and Visual Studio Code (a lightweight, highly extensible code editor with support for many languages).

IDEs commonly utilize hierarchical trees to represent project structures. The hierarchical tree might include source code files, libraries, resources, and other project components. Developers can easily navigate, organize, and manipulate project elements within the IDE. Document trees show the hierarchy of classes, methods, and functions in a codebase. Many IDEs used for programming feature a document tree in the form of a project explorer. The document tree displays the structure of projects, including folders, source code files, assets, and resources to help programmers manage their codebase and navigate between different parts of a project.

A document tree, often referred to as a tree structure or hierarchical tree, is a graphical representation of data organized in a hierarchical manner. The document tree resembles the structure of a tree, where each node can have child nodes branching out from each node. Document trees are commonly used to represent relationships, hierarchies, and organized sets of data. Nodes in a document tree have parent-child relationships. Each node can have zero or more child nodes, forming a hierarchical structure. The topmost node in the tree is known as the root node. All other nodes are descendants of the root node. Nodes can branch out into multiple child nodes, creating branches within the tree. Nodes with no child nodes are often referred to as leaves or terminal nodes. Leaves or terminal nodes represent the end points of the hierarchy. Document trees are typically displayed graphically, with lines connecting parent nodes to their child nodes. Child nodes are nested within their parent nodes, indicating their hierarchical relationships. Document trees are useful for representing organized data such as file systems, organizational structures, and project hierarchies. Users can navigate through the tree by expanding or collapsing nodes to reveal or hide their child nodes.

In one or more embodiments, the target application 604 includes an application Graphical User Interface (GUI) 610, a controller 612, and a Graphical User Interface (GUI) manager 614. The application GUI 610 is the visual representation of the target application 604 through which a user interacts with the target application 604. The application GUI 610 presents information to the user in a clear and understandable manner and collects user input. The application GUI 610 includes a plurality of interface elements 616.

In one or more embodiments, the interface elements 616, also known as user interface (UI) elements or widgets, are visual components of the application GUI 610 used to interact with the target application 604. The interface elements 616 facilitate communication between the user and the target application 604. The interface elements 616 may include buttons, text fields, checkboxes, radio buttons, sliders, progress bars, labels, and icons. Buttons are clickable elements that initiate an action when pressed. Buttons can trigger functions like saving, submitting a form, or navigating to a different screen. Text fields are areas where users can input text or numbers and are used for tasks like entering usernames, passwords, search queries, or comments. Checkboxes are boxes that allow users to select or deselect options from a list of choices. Radio buttons are circular buttons that let users choose one option from a set of mutually exclusive options. Dropdown lists, also referred to as combo boxes, are lists that display a set of options that allow users to select one option from the list. Sliders are controls that allow users to adjust a value within a range by dragging a handle along a bar. Progress bars are indicators that show the progress of a task, providing visual feedback on how much has been completed. Labels are non-interactive text elements used to provide descriptions, instructions, or information about other interface elements. Icons are pictorial symbols that represent functions, features, or information.

In one or more embodiments, the interface elements 616 include menus, dialog boxes, pop-ups, toolbars, text areas, image elements, hyperlinks, and video and audio players. Icons provide visual cues for users. When an icon is representative of a particular file, the icon is associated with metadata mapping it to the particular file. The metadata may include the file type, location, size, and modification date. Menus are lists of options that users can select to perform various actions and are often found in the menu bar at the top of the application window. Tabs are controls that organize content into multiple sections and can be used to switch between sections to access different sets of information or features. Dialog boxes are pop-up windows that request user input or provide information and are used for tasks like file selection, confirmation prompts, or displaying errors. Toolbars contain buttons or icons that provide quick access to frequently used functions and are often located at the top or sides of the application window. Scrollbars are controls that allow users to navigate through content that does not fit within the visible area of a window or frame. Text areas are larger input fields for entering multiline text, such as in a text editor or message composition. Image elements are graphics or images that are displayed within the GUI and provide visual content to the user. Hyperlinks are text or graphical elements that, when clicked, navigate to another location or resource and are often used in web-based GUIs. Video and Audio Players are elements that allow users to play and control multimedia content like videos and audio files.

In one or more embodiments, the interface elements 616 of the application GUI 610 are responsive to user actions 618. The user actions 618 are interactions or operations performed by a user in relation to the interface elements 616 and other components of the application GUI 610 to interact with a target application 604.

In one or more embodiments, the user actions 618 include clicking a button, typing in a text field, selecting an option from a dropdown list, checking a checkbox, and choosing a radio button. Clicking on a button with the mouse triggers an action associated with the button, such as submitting a form or initiating a process. Entering text using the keyboard populates the text field with the entered information, which can be used for tasks like search queries or data entry. Clicking on a dropdown list and choosing an option sets a specific value or option from the list, often used for selecting preferences or filtering data. Clicking on a checkbox to toggle its state selects or deselects the checkbox, indicating a true/false or on/off state. Clicking on a radio button to select an option from a set of mutually exclusive choices selects the chosen option while deselecting any others in the same group.

In one or more embodiments, the user actions 618 include dragging and dropping, scrolling, right-clicking for context menu, hovering over an element, double-clicking, resizing windows, and using keyboard shortcuts. Clicking and holding an element, then moving it to a new location before releasing moves or reorders elements within the interface, often used for tasks like rearranging items in a list. Using the scroll wheel on a mouse or dragging a scrollbar navigates through content that does not fit within the visible area of a window or frame. Right-clicking an interface element opens a context menu with options relevant to the selected element. Moving the mouse pointer over an interface element may trigger visual feedback or provide additional information through tooltips. Quickly clicking a mouse button twice may initiate actions like opening a file or editing a document. Clicking and dragging the edges or corners of a window adjusts the size of the window to fit the user's preference. Pressing specific key combinations, e.g., Ctrl+S for saving, performs a specific action or command without using the mouse.

In one or more embodiments, the application GUI 610 of the target application 604 responds to the user actions 618 by executing a predefined command. The command dictates how the target application 604 behaves in response to the user actions 618. For example, typing text into a search bar may trigger a command to initiate a search based on the entered query. The commands define the behavior and functionality of the target application 604. The commands may encapsulate the logic required to perform specific tasks, such as opening a file, sending a message, performing a calculation, or navigating to a different section of the target application 604.

In one or more embodiments, each of the user actions 618 within the target application 604 is assigned a unique action ID. The unique action ID is a specific identifier that represents a particular command or operation that the application performs. For example, in a photo editing application, commands could include “Crop Image,” “Apply Filter,” and “Rotate.” The target application 604 uses the unique action ID associated with the chosen action to identify what the user wants to do. The unique action ID is like a code that the target application 604 understands as a reference to a particular task. Each unique action ID is linked to a set of instructions, often in the form of commands, that need to be executed to carry out the desired action. Based on the identified action, the application generates the appropriate command or sequence of commands required to complete the action. These commands can encompass a range of activities, such as updating data in the application's memory, interacting with external services or devices, and modifying the user interface. The exact nature of the commands generated depends on the specifics of the action being performed. The generated commands are executed by the internal components or subsystems of the target application 604.

In one or more embodiments, executing the command calls a function. The functions often require specific inputs to perform their operations. These inputs are specified using data arguments. The data arguments are defined by their parameter names in the function's definition. The parameter names indicate the values that the function expects to receive. When calling a function, the values, referred to herein as data arguments, are provided for the parameters declared in the definition of the function. The function uses the provided data arguments to perform its tasks, potentially returning results or affecting the program's behavior. Functions can have multiple data arguments, allowing for more complex operations that involve multiple input values.

In one or more embodiments, system features 620 are required for the application GUI 610 to execute a command. The system features 620 refer to specific conditions, states, context, modes or environments in which a user interface element or interaction occurs. The system features 620 encompass the information and circumstances that influence the behavior, appearance, and functionality of the graphical elements within the application GUI 610. The system features 620 may include one or more interface elements 616 that must be displayed in order for successful execution of a command. For example, the system feature 620 may include multiple levels of a hierarchical tree that are expanded to display a terminal node that is the object of a user action. The system feature 620 includes each of the parent nodes necessary for displaying the terminal node. The system features 620 may include text boxes or fields that include data arguments provided for execution of a command associated with the user action. The system features 620 may correspond to back-end features such as instantiation of a type (e.g., a Java class) to generate an object that is needed to execute the command.

In one or more embodiments, the system features 620 include modes for the target application 604 that provide different levels of access or functionality. The mode may be dependent on a status or characteristics of a user. For example, a user may be a guest, e.g., an unregistered or non-logged in user, or an employee, e.g., a registered and authenticated user with specific privileges. In guest mode, users may have restricted access to application features and content. The guest user may be able to view certain public information, but cannot perform actions that require authentication. Guest users typically do not have the ability to personalize their experience, and typically cannot save preferences, settings, or data. Guest users often cannot store or save any data within the application. The target application 604 may not track or store user-specific data for guest users. In contrast, in employee mode, employees, as authenticated users, generally have access to a full range of features and functions offered by the application. These may include advanced tools, settings, and administrative functions. Employees may store and save data within the target application 604. The target application 604 may track and store user-specific data for employees. Employees, especially those with administrative roles, may have special privileges to manage users, access control settings, and other system configurations.

In one or more embodiments, in addition to guest and employee modes, the target application 604 may incorporate various other modes to cater to different user needs and scenarios. Common user modes provided for in the target application 604 may include, administrator mode, user mode, moderator mode, demo mode, and offline mode. Administrators have complete control over the target application 604, including user management, settings configuration, and access control. Administrators may also have access to backend functionalities, such as database management, server settings, and system configurations. Standard registered users have access to core features and functionalities of the target application 604. Regular users might have limited administrative capabilities, such as editing their own profile or managing personal settings. Moderators have the authority to review and moderate user-generated content, such as comments, posts, or uploads. Moderators may have access to specialized tools for reviewing and managing flagged content. Demo users can explore a simplified or restricted version of the application to get a feel for its capabilities. In certain contexts (like e-commerce), demo users may be able to interact with the target application 604 but not perform actual transactions. Offline mode users may access certain features or content even when not connected to the internet. Any actions taken in offline mode may be synchronized with the server once an internet connection is reestablished.

In one or more embodiments, common user modes include, read-only mode, testing or QA mode, training mode, and accessibility mode. In read-only mode, users may only view content or data without the ability to make changes or perform transactions. Read-only mode is often used in reporting or analytic applications where users need access to data but are unable to make direct modifications. Applications may allow administrators to create custom roles with specific access permissions, allowing for fine-grained control over different user types. Testing or QA mode allows testers and quality assurance professionals to evaluate new features or changes before the changes are deployed to the production environment. Training mode provides users with step-by-step tutorials or interactive guides to help them learn how to use the target application 604 effectively. Accessibility mode provides additional accessibility options, such as screen reader compatibility, high contrast themes, and keyboard navigation enhancements.

In one or more embodiments, the controller 612 of the target application 604 handles user input and makes decisions based on that input. The controller 612 acts as an intermediary between the application GUI 610 and underlying logic or data of the target application 604.

In one or more embodiments, the controller 612 of the target application 604 includes a command execution module 622. The command execution module 622 is a component responsible for interpreting and carrying out commands or instructions provided by a user or another part of the system 600. The command execution module 622 takes input (commands) and parses the input to understand the intent or action that needs to be performed. This involves breaking down the command into its components, such as the command verb and any data arguments or parameters. The command execution module 622 verifies that the command is well-formed, that the required arguments are present, and that the user or entity issuing the command has the necessary permissions. Once a command is validated and any necessary checks are performed, the command execution module 622 carries out the requested action, including, for example, interacting with other parts of the system 600, such as databases, APIs, or other modules. The command execution module 622 may need to interact with other modules or components of the target application 604 or the operating system 602 to complete its tasks, including, for example, calling functions from other modules or sending messages to different parts of the system 600.

In one or more embodiments, the GUI manager 614, also known as a window manager or GUI toolkit, is a software component or library that provides tools and functions to create and manage the visual elements and interactions in a graphical user interface. The GUI manager 614 offers an abstraction layer between the target application code and the underlying graphics of the operating system 602 and input systems, making it easier for developers to create user-friendly interfaces. The GUI manager 614 handles task such as arranging buttons and other elements on a screen, resizing windows, and managing fonts and colors.

In one or more embodiments, the GUI manager 614 includes event sources 624, an event bus 626, and event handlers 628. The event sources 624, the event bus 626, and the event handlers 628 are part of a Publisher-Subscriber pattern allowing for decoupled communication between different parts of the target application 604.

In one or more embodiments, the event sources 624 are components or entities that generate events in response to specific actions or occurrences. The event sources 624 act as publishers by producing events that contain information about the action that occurred. The event sources 624 can be user interactions like clicking a button, pressing a key, or moving the mouse, or the event sources 624 could be system events like a timer expiring. When events occurs, the event sources 624 create event objects that encapsulate information about the events, such as the event types and any relevant data. The event sources 624 are responsible for notifying the event bus 626 that events have occurred and providing the event objects to the event bus 626.

In one or more embodiments, the event bus 626 is an intermediary that facilitate the communication between publishers (event sources 624) and subscribers (event handlers 628 and other components). The event bus 626 introduces an additional layer of decoupling between the event sources 624 and the event handlers 628. More particularly, the event bus 626 provides a centralized mechanism for publishing events and routing the events to interested subscribers. The event bus 626 categorizes the events into channels or topics based on their type, allowing subscribers to subscribe to specific channels of interest. When an event is published on a channel, the event bus 626 forwards the event to all registered event handlers 628 for that channel.

In one or more embodiments, the event handlers 628, also known as event listeners, are the subscribers in the Pub-Sub pattern. The event handlers 628 register with the event bus 626 to receive events of specific types or from specific channels. When the event bus 626 forwards the event to all the registered event handlers 628 for the specific channel, the event handlers 628 respond by executing their predefined logic, which can involve updating the application GUI 610, processing data, and triggering other events. Publishers and subscribers do not need direct references to each other and instead interact through the event bus 626, thereby promoting modularity, maintainability, and separation of concerns in the application's architecture.

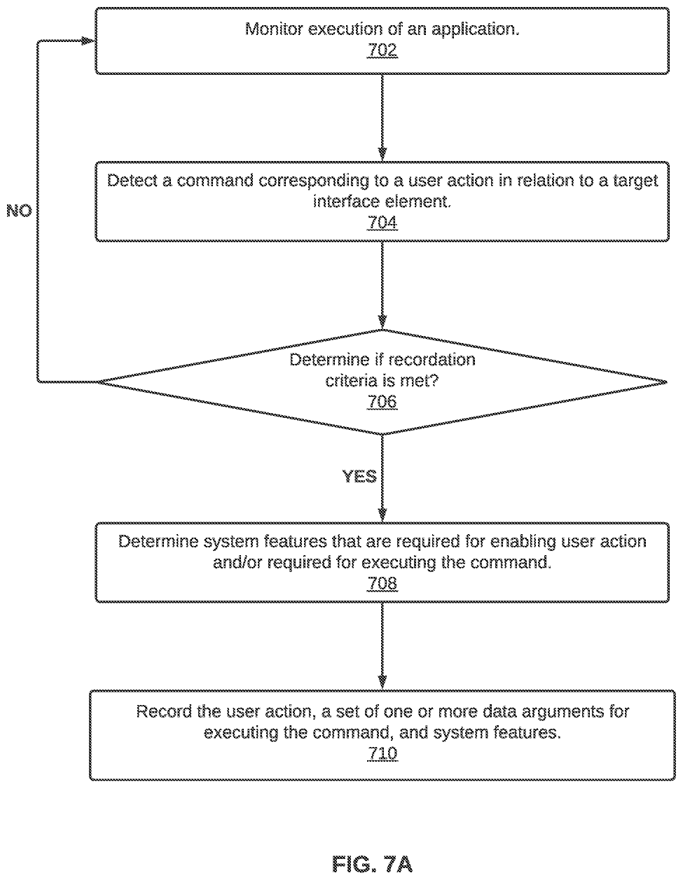

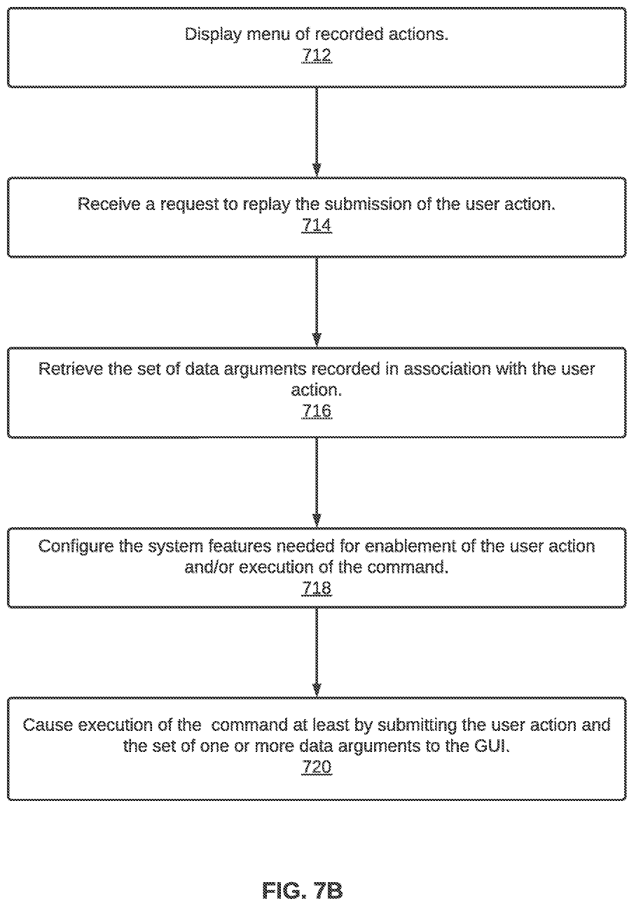

In one or more embodiments, the control application 606 refers to hardware and/or software configured to perform operations described herein for recording user actions along with data arguments for replay. The control application 606 may be a plugin, add-on or extension that runs along side or on top of the target application 604. The control application 606 coordinates the capturing, storage, and playback of user actions to provide an enhanced developer experience. Examples of operations for recording user actions along with data arguments for replay are described below with reference to FIG. 7.

In an embodiment, the control application 606 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the control application 606 captures and records various user actions 618 performed relative to the interface elements 616 of the application GUI 610. As detailed above, the user actions 618 may include button clicks, text input, and menu selections. Each user action is recorded along with relevant metadata, any associated data arguments, and a timestamp. The recorded user actions are stored in a structured format, e.g., key value pair. The storage mechanism allows for efficient retrieval and replay of the user actions and associated data arguments.

In one or more embodiments, the control application 606 enables the replaying or re-execution of recorded user actions. When a user requests to replay a specific stored action, the control application 606 retrieves the recorded data arguments and triggers the appropriate actions on the interface element 616 of the application GUI 610 to reproduce the original user action. Users can navigate through their interaction history by selecting shortcuts for the specific actions to replay. This feature can be helpful for re-executing sequences of actions that might otherwise be time consuming, e.g., requiring navigating through multiple levels of a document tree. The control application 606 ensures the persistence and organization of the recorded actions. The control application 606 may need to synchronize with the interface elements 616 of the application GUI 610 of the target application 604 and their state to accurately replay actions. Synchronizing the interface elements 616 of the application GUI 610 is accomplished through the pub-sub pattern described above.

In one or more embodiments, the control application 606 includes a command detection module 630, a command evaluation module 632, a recording engine 634, a serializer module 636, a sorting module 638, a configuration module 640, a machine learning model 642, a replay engine 644, and a controller GUI 646.

In one or more embodiments, the command detection module 630 is a software component that is responsible for identifying and interpreting user inputs or signals as specific commands or actions within the target application 604. The command detection module 630 continuously monitors user inputs, which may include keyboard events, mouse movements, button clicks, and touch gestures. The command detection module 630 may use pattern recognition techniques to identify sequences or combinations of inputs that correspond to specific actions or commands. The command detection module 630 maps detected input patterns to predefined commands or actions within the target application 604. The command detection module 630 maintains a mapping of recognized input patterns to the corresponding commands. Contextual information, e.g., system features 620, influence how inputs are interpreted. For example, the same input might trigger different commands based on the current state of the application. In touch-based interfaces, the command detection module 630 may recognize gestures like swipes, pinches, and taps, and map the gestures to appropriate commands.

In one or more embodiments, the command detection module 630 handles inputs from different input devices (keyboard, mouse, touch screen) and adapts to various platforms (desktop, mobile, web). After a command is detected and mapped, the command detection module 630 may communicate with the command execution module 622 of the target application 604 to trigger the corresponding action or command.

In one or more embodiments, the command evaluation module 632 is a component of the control application 606 that assesses and processes commands or actions of the target application 604 that are input by users or triggered by events. The command evaluation module 632 is responsible for determining whether a given command should be recorded within the context of the target application 604. The command evaluation module 632 ensures that the control application 606 operates reliably and adheres to predefined rules and constraints.

In one or more embodiments, the command evaluation module 632 determines if a user action or command is an action to be recorded based on recordation criteria 654. The command evaluation module 632 may determine that a user action should be recorded based on the type of command invoked by the user action. For example, the command evaluation module 630 may only record application commands, e.g., commands specific to the target application 604, and ignore system commands, e.g., internal commands such as cut, paste, undo, redo. The command evaluation module 630 may record all user actions that result in execution of a command. The command evaluation module 632 may record all user actions that result in execution of a command that require one or more data arguments. The command evaluation module 634 may include a list of commands to record and/or a list of commands to ignore. When the command evaluation module 632 determines that a user action and the associated command satisfy the recordation criteria 654, the command evaluation module 632 provides instruction to the recording engine 634 to record the submission of the user action as well as any data arguments generated in response to the user action.

In one or more embodiments, the recording engine 634, also known as a memoization tool, is a software or programming utility used to implement recording of user actions relative to interface elements. The recording engine 634 records or caches a user submission of a user action to an interface element along with the data arguments used as input for executing a command associated with the user action. By recording the user action and the related inputs for playback, the recording engine 634 improves the efficiency and performance of the developer experience by avoiding redundant user actions when the developer seeks to perform the action on subsequent occasions. As will be described in further detail below, instead of reperforming all the sub-tasks required for reperforming the recorded user action and selecting or entering the data arguments for executing the command associated with the user action, the developer is able to select the recorded user action from a list of recorded user actions for submission to the application GUI 610 of the target application 604.

In one or more embodiments, the recorded user actions are stored in local memory as key value pairs. The key of the key value pair is the unique action ID assigned to the action or command associated with the user action and the value of the key value pair is the data arguments required for executing the command. The data arguments may include the data object itself or metadata mapping to the data object. The recorded user actions may only be maintained for the specific instance of the target application 604, e.g., the user session. Thus, when the target application 604 is closed or restarted, the recorded user actions are lost. Alternatively, the recorded user actions may be stored or persisted for a particular number of user sessions, for a particular length of time, or indefinitely.

In one or more embodiments, the serializer module 636 is used to save the recorded actions for future use. The serializer module 636 is a component or library responsible for converting the key value pairs that represent the recorded user actions into a format that can be easily stored, transmitted, or reconstructed at a later time. The serializer module 636 also handles deserializing the serialized data, i.e., converting the serialized data back into its original form. The serializer module 636 converts the key value pairs representing the recorded user action into a format that can be easily saved to a file, sent over a network, or stored in a database. The serializer module 636 represents data structures in a way that preserves the structure of the key value pairs, including nested objects, arrays, and their relationships. The serializer module determines the format in which the data is serialized. Common formats include JSON (JavaScript Object Notation), XML (eXtensible Markup Language), and Protocol Buffers. The serializer module 636 may handle various data types, including primitive types (integers, floats, strings) and complex types (objects, lists, dictionaries). If the data arguments contain relationships between different objects or entities, the serializer ensures that these relationships are maintained during serialization and deserialization.

In one or more embodiments, the sorting module 638 includes one or more algorithms for sorting the recorded user actions for more efficient use by the user(s). The sorting module 638 may sort the recorded user actions based on most recently used recorded user actions, most frequently used recorded user actions, and most likely to be used recorded user actions based on the current system features. The sorting module 638 may also take into consideration other factors including, for example, project types, users, and user preferences.

In one or more embodiments, the machine learning model 642 is a model trained to provide or suggest to the user a selection of recorded user actions. When recorded user actions are persisted for use by more than one user and/or across multiple user sessions, the machine learning model 642 may be trained to determine the recorded user actions that the user is most likely to use during a specific session or with regards to a particular project type or application. The suggested user selections of recorded user actions may be specific to the user and/or to specific system features.

In one or more embodiments, the machine learning model 642 provides the selection of recorded user actions at the beginning of the user session and persists throughout the user session. Alternatively, the selection of recorded user actions provided by the machine learning model 642 is updated throughout the session. Updating of the selection of suggested recorded user actions provided by the machine learning model may occur at set intervals or in response to changes in the system features 620 of the target application 604. The suggested selection of recorded user actions may also be updated in real-time, and may be updated in response to user actions recorded during the particular session.

In one or more embodiments, feedback for the machine learning model 642 is generated by analyzing (a) the selection of recorded user actions provided by the machine learning model 642, (b) the recorded user actions available for selection by the machine learning model 642 that were not provided to the user for selection, (c) the recorded user actions from the selection of recorded user actions provided by the machine learning model 642 that were selected by the user, and (d) newly recorded user actions whether previously recorded and not provided as selections to the user or entirely new recorded actions. The feedback may be used to retrain the machine learning model 642 to provide a selection of recorded user actions that are more likely to be selected by the user during a particular session.

In one or more embodiments, the machine learning model 642 incorporates selections made by the user using the configuration module 640 to more accurately predict a selection of recorded user actions that may be used by the user during a session.

In one or more embodiments, the configuration module 640 offers a convenient and efficient way for users to customize configurations of the control application 606, e.g., a user interface. The configuration module 640 may be accessible through the controller GUI 646. Configurations that can be customized by the user using the configuration module 640 may include what criteria is used for recording user actions and how the recorded user actions are sorted. The configuration module 640 may maintain a user profile for each user, and each profile may be specific to a particular application or project. The user's preferences may automatically load each time the user logs in to the target application 604. Alternatively, the configuration module 640 may present the user with options to customize the configuration of the control application 606 each time the user begins a session on the target application 604. The configuration module 640 may also be accessible during a session to permit modifying the configuration of the control application 606 in real time. The configuration module 640 may include options to clear the cache of recorded user actions and/or to remove particular recorded user actions.

In one or more embodiments, the replay engine 644 handles the replay of the recorded user action and provides the data arguments used as inputs. More particularly, when an entry or shortcut for a recorded user action is selected from a menu of recorded user actions 648, the replay engine 644 retrieves the stored data arguments corresponding to the user action. The replay engine 644 then replays the submission of the user action to the interface element and provides the data arguments required to cause execution of the command associated with the user action. Replaying the submission of the user action to the interface element includes restoring the system features 620 necessary for replaying the user action. Restoring the system features 620 may include opening levels of a document tree to display a terminal node corresponding to a target interface element, selecting interface elements, entering text in user fields, and/or initializing a mode for the target application 604.

In one or more embodiments the controller GUI 646 of the control application 606 is a component responsible for interacting with the control application 606. The controller GUI 606 may be initiated using a shortcut key or by engaging an interface element on the application GUI 610. For example, the controller GUI 646 may be engaged on a macOS system using a shortcut “cmd+L”. Initiating the controller GUI 646 provides the user with the menu of recorded user actions 648. The order of the selections in the menu of recorded user actions 648 is configurable. The selections may be presented in order of frequency of use, in order of most recently used, in order of most likely to be used, or in any other manner. The menu of recorded user action 648 may be limited to a set number of selection, e.g., 5, 10, 20, or may include a scrollable list of all selections available. Selecting an entry in the menu of recorded user actions 648 may be accomplished by highlighting the entry and pressing the “Enter” key on a keyboard or by clicking or double-clicking on the entry. The menu of recorded user action 648 may be used to delete an entry or to prioritize an entry or mark an entry as a favorite. The menu of recorded user action 648 may include one or more interface elements for rearranging the order of entries.

In one or more embodiments, the data repository 608 is any type of storage unit and/or device (e.g., a file system, database, collection of tables, or any other storage mechanism) for storing data. Further, the data repository 608 may include multiple different storage units and/or devices. The multiple different storage units and/or devices may or may not be of the same type or located at the same physical site. Further, the data repository 608 may be implemented or executed on the same computing system as the target application 604 and the control application 606. Alternatively or additionally, the data repository 608 may be implemented or executed on a computing system separate from the target application 604 and the control application 606. The data repository 608 may be communicatively coupled to the target application 604 and the control application 606 via a direct connection or via a network.

Information describing the target application 604 and the control application 606 may be implemented across any of the components within the system 600. However, this information is illustrated within the data repository 608 for purposes of clarity and explanation.

In one or more embodiments, the data repository 608 includes, the system commands 650 for the operating system 602, the application commands 650 for the target application 604, the recordation criteria 654 for use by the command evaluation module 632 of the control application 606, the data arguments 656 required for executing the system commands 650 and the application commands 652, the key value pairs 658 for storing the recorded user actions, and the machine learning algorithms 660 for the machine learning models 642.

In one or more embodiments, the system commands 650, also known as system-level commands, internal commands, or system-level operations, are instructions or operations that directly interact with the operating system 602. The system commands 650 perform tasks related to system management, configuration, and control. The system commands 650 operate across all applications and include operations such as cut, paste, redo, and undo. The system command 650 may also include expanding levels or nodes of hierarchal trees.

In one or more embodiments, the application commands 652, also known as application-level commands or application-specific commands, are specific instructions or operations that are unique to the target application 604. The application commands 652 are designed to interact with and control the functionalities provided by the target application 604 itself. Unlike the system commands 650, which interact with the operating system 602, the application commands 652 are tailored to the features and capabilities of the target application 604.

In one or more embodiments, the target application 604 includes a fixed number n of application commands 652. Each application command 652 is identified with a unique action ID. The unique action ID is used as the key in a key value pair used to record the user actions. Examples of application commands for word processing applications, e.g., Microsoft Word, Google Docs, include formatting commands, inserting elements, editing commands, and spell-check and grammar-check commands. Examples of application commands for spreadsheet applications, e.g., Microsoft Excel, Google Sheets, include formulas and functions, cell formatting commands, data manipulation commands, and chart creation commands. Examples of application commands for integrated development environments (IDEs), e.g., Visual Studio, Eclipse, IntelliJ IDEA, include auto-ident, format code, extract method/function, change method signature, start/stop debugging, create new file, and open/close project.

In one or more embodiments, the recordation criteria 654 for recording user actions include the type of command associated with the user action. For example, the recordation criteria 654 may include user actions associated with only application commands 652. The recordation criteria 654 may include user actions associated with both system commands 650 and application commands 652. The recordation criteria 654 may include user actions associated with commands that require one or more data arguments 656. The recordation criteria 654 may include user actions associated with specific system commands 650 and/or specific application commands 650. The recordation criteria 654 may specifically exclude specific system commands 650 and/or specific application commands 652.

In one or more embodiments, the data arguments 656, also referred to as function arguments or data parameters, are values or variables that are provided to a command of the operating system 602 or the target application 604 for execution of the command. The data arguments 656 serve as input to a function, allowing the function to operate on or with the specific data. The data arguments 656 provide a way to pass information to a function so that the function can perform its intended task using the provided values. The data arguments 656 can be of various data types, such as numbers, strings, booleans, arrays, objects, or custom data structures. The data arguments 656 can be passed to functions either by their position (positional arguments) or explicitly by naming the parameter (named arguments). In many programming languages, data arguments are passed to functions by value, meaning a copy of the value is passed rather than the original data itself.

In one or more embodiments, the key value pair 658 is the data structure used to store the recorded user action and data arguments required to execute the command associated with the user action. The key value pair 658 includes two parts, a unique key and an associated value. The key of the key value pair is the user action, identified using the unique action ID, and the value of the key value pair are the data arguments. The key value pairs 658 may include a timestamp for use by the sorting module 638 for determining the most recently used recorded user actions. The key value pairs 658 may include a frequency tracker for use by the sorting module 638 in determining the most frequently used user actions. The key value pairs 658 may include a unique user ID for identifying recorded actions for a particular user. The key value pairs 658 may include a session ID for identifying recorded actions for a particular session. The key value pairs may include an application ID for identifying actions for a particular application.

In one or more embodiments, the machine learning algorithms 660 are algorithms that are iterated to train the machine learning model 642 to best map a set of input variables to an output variable, using a set of training data. The training data includes datasets and associated labels. The datasets are associated with input variables for the machine learning model 642. The associated labels are associated with the output variable of the machine learning model 642. The training data may be updated based on, for example, feedback on the accuracy of the current machine learning model 642. Updated training data is fed back into the machine learning algorithm, which in turn updates the machine learning model 642.

The machine learning algorithm 660 generates the machine learning model 642 such that the machine learning model 642 best fits the datasets of training data to the labels of the training data. Additionally, or alternatively, the machine learning algorithm 660 generates the machine learning model 642 such that when the machine learning model 642 is applied to the datasets of the training data, a maximum number of results determined by the machine learning model 642 matches the labels of the training data. Different target models may be generated based on different machine learning algorithms and/or different sets of training data.

The machine learning algorithm 660 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 5. Recording User Actions and Data Arguments for Replay

FIG. 7A illustrates an example set of operations for recording user actions for replay in accordance with one or more embodiments and Figured 7B illustrates an example set of operations for replaying the user actions in accordance with one or more embodiments. One or more operations illustrated in FIGS. 7A and 7B may be modified, rearranged, or omitted all together. Accordingly, the particular sequence of operations illustrated in FIGS. 7A and 7B should not be construed as limiting the scope of one or more embodiments.

One or more embodiments monitor execution of an application. (Operation 702). The application being monitored is referred to as a target application and may include any software program that uses a graphical user interface (GUI) to receive user actions and execute commands associated with the user actions. The target application may include word processors, spreadsheet applications, image editors, and integrated development environments (IDEs).

In one or more embodiments, the target application is monitored by a control application. The control application is a plugin, add-on, or other extension of the target application and monitors user actions relative to interface elements of the application GUI. The control application records the user actions along with the data arguments associated with the user actions, and replays submission of user actions along with providing the data arguments associated with the user actions.

In one or more embodiments, execution of the target application includes performing a plurality of user actions relative to interface elements of the application GUI of the target application. The user actions may include navigating hierarchical trees, clicking buttons, entering data in text fields, selecting options from dropdown lists, checking checkboxes, choosing radio buttons, dragging and dropping interface elements, scrolling, right-clicking for context menus, hovering over interface elements, double-clicking interface elements, resizing windows, and using keyboard shortcuts.

One or more embodiments detect a command corresponding to a user action in relation to a target interface element. (Operation 704). A plurality of actions may be performed by a user during execution of the target application. The user actions are performed relative to interface elements of the application GUI of the target application. The user actions may be associated with application commands, e.g., commands specific to the target application, or system commands, e.g., commands recognized globally. A command detection module of the control application detects the commands corresponding to the submission of the user actions. The command detection module intercepts transmission of the commands from the application GUI to a command execution module of the target application.

In one or more embodiments, detecting the command includes detecting the inputs or parameters that are submitted along with the command. For example, the application GUI may include a form with (a) multiple text fields, e.g., “First Name” and “Last Name”, and (b) a “Submit” button. When the user action, e.g., “click the Submit Button” occurs, the corresponding command is a transmit command. The inputs provided by the GUI with the transmit command may include the values in the “First Name” and the “Last Name” fields. Interception of the transmit command includes detecting, identifying, and recording the transmit command and the values, e.g., “John” and “Doe.”

One or more embodiments determine if recordation criteria is met. (Operation 706). Determining if recordation criteria is met includes determining whether a command meets one or more recordation criteria. Recording a command is responsive to determining that the command meets one or more recordation criteria. The recordation criteria defines characteristics of the user action, characteristics of the command, and/or characteristics of the data arguments used for execution of the command. For example, the recordation criteria may include (a) any command recognized by the application GUI, (b) only application commands, or (c) both system commands and application commands. The recordation criteria may include any command identified in a list of commands. The recordation criteria may include commands that require one or more data arguments for execution. The recordation criteria may include specific system commands and/or specific application commands. The recordation criteria may include any system command and/or application command that is not specifically excluded.

In one or more embodiments, when the recordation criteria for a command corresponding to a user action in relation to a target interface element is not met, the control application continues monitoring execution of the target application. When the recordation criteria for a command is met, the control application performs a recording operation.

One or more embodiments determine system features that are required for enabling user action and/or required for executing the command. (Operation 708). The application GUI may require system features for executing a command. The system features refer to specific conditions, states, context, modes or environments in which a user interface element or interaction occurs. The system features encompass the information and circumstances that influence the behavior, appearance, and functionality of the graphical elements within the application GUI. The system features may include one or more interface elements that must be displayed in order for successful execution of a command. For example, the system feature may include multiple levels of a hierarchical tree that are expanded to display a terminal node that is the object of a user action. The hierarchical tree includes each of the parent nodes necessary for displaying the terminal node. The system features may include text boxes or fields that include data arguments provided for execution of a command associated with the user action. The system features may include modes for the target application that provide different levels of access or functionality.

One or more embodiments record the user action, a set of one or more data arguments for executing the command, and system features. (Operation 710). A recording engine of the control application records the user action associated with the command and the set of one or more data arguments for executing the command. The data arguments are used by the target application to determine the specific behavior or parameters of the user action. The recording engine may also record system features. The recording engine begins recording in response to detection of the command by the command detection module. In an embodiment, the command and input values that were intercepted/detected at Op 704 are recorded. As used herein, “recording” includes storing the command and values in a text format, whether that be JSON, or in a table, or a key-value pair, or some other human readable format.

In one or more embodiments, the application GUI determines the set of one or more data arguments required for execution of the command. The application GUI determines the set of one or more data arguments based on user input received in relation to the one or more interface elements of the application GUI. The set of one or more data arguments are recorded in association with the user action. The recorded user actions and associated data arguments may be stored in a structured format. The structured format may include key value pairs and may be stored as a log file, database entries, or other data structure. The values may be data objects or metadata mapping to the data objects.

One or more embodiments display a menu of recorded actions. (Operation 712). The menu of recorded actions is displayed through a controller GUI initiated using a shortcut key or by engaging an interface element on the application GUI. For example, the controller GUI may be engaged on a macOS system using a shortcut “cmd+L”. Initiating the controller GUI provides the user with the menu of recorded actions. The menu of recorded actions includes a set of stored user actions that may be replayed. The user action may be identified by a unique action ID associated with the user action. The set of stored user actions also includes the set of one or more data arguments stored in association with the user action. The order of the selections in the menu of recorded actions may be configurable.

One or more embodiments receive a request to replay the submission of the user action. (Operation 714). The request to replay the submission of the user action may include selection of the user action from the replay menu. When a request to replay a specific set of actions is received, a replay engine is triggered.

One or more embodiments retrieve the set of data arguments recorded in association with the user action. (Operation 716). The replay engine retrieves the recorded user actions and their associated data arguments based on the request to replay the submission of the user action.

One or more embodiments configure the system features needed for enablement of user actions and/or execution of the command. (Operation 718). As noted above, the system features refer to specific conditions, states, context, modes or environments in which a user interface element or interaction occurs and encompass the information and circumstances that influence the behavior, appearance, and functionality of the graphical elements within the application GUI.

In one or more embodiments, configuring the system features needed for enablement of the user actions and/or execution of the command includes displaying one or more interface elements within the application GUI as the one or more interface elements must be displayed to successful execute a command. This may include expanding multiple levels of a hierarchical tree to display a terminal node that is the object of a user action, displaying text boxes or fields that include data arguments, and/or initiating a mode for the target application that provides a particular level of access or functionality. Configuring the system features needed for enablement of user actions may be accomplished automatically through operation of a publisher-subscriber pattern. The system features that enable successful execution of a command may correspond to back-end features such as instantiation of a type (e.g., a Java class) to generate an object that is needed to execute the command.

One or more embodiments cause execution of the command at least by submitting the user action and the set of one or more data arguments to the GUI. (Operation 720). Submitting the user action to the GUI is performed programmatically and is received by the GUI as if the user were performing the action on the target interface element. The user action and the set of one or more data arguments may be submitted to the GUI subsequent to causing the display of the interface elements within the GUI. The target application processes the simulated user actions along with the supplied data arguments as if the user had performed the user action and provided the data arguments.

In one or more embodiments, the user action and the set of one or more data arguments are submitted to the GUI subsequent to causing the display of the interface elements within the GUI. Subsequent to receiving the request to replay the submission of the user action, the control application computes a set of one or more commands that need to be executed to enable successful execution of the first command. The execution of the one or more commands may result in the display of the interface elements within the GUI as they would need to be displayed to perform the original user action. The set of one or more commands are executed prior to submitting the user action and the set of one or more data arguments to the GUI. The target application then performs the operations as if the user had performed the action.

### 6. Example Embodiments

Detailed examples are described below for purposes of clarity. Components and/or operations described below should be understood as specific examples which may not be applicable to certain embodiments. Accordingly, components and/or operations described below should not be construed as limiting the scope of any of the claims.

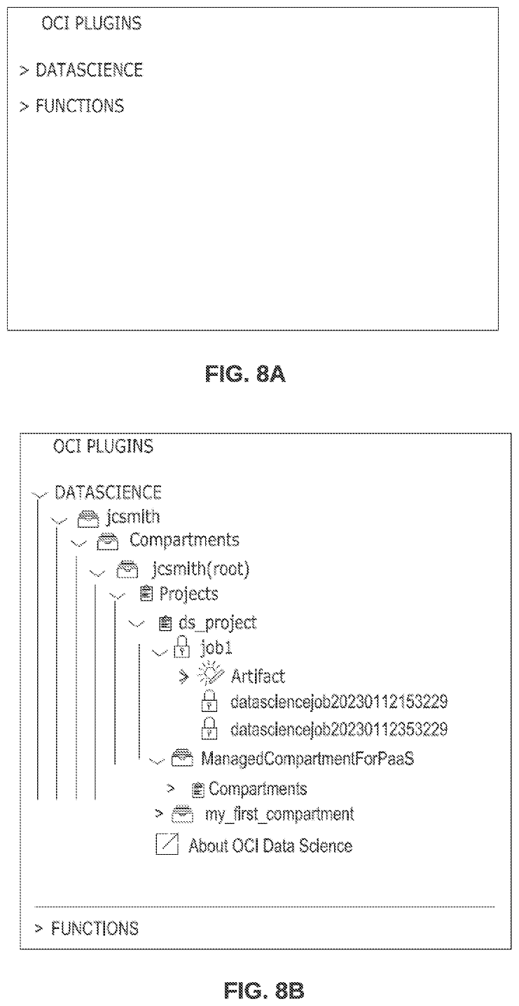

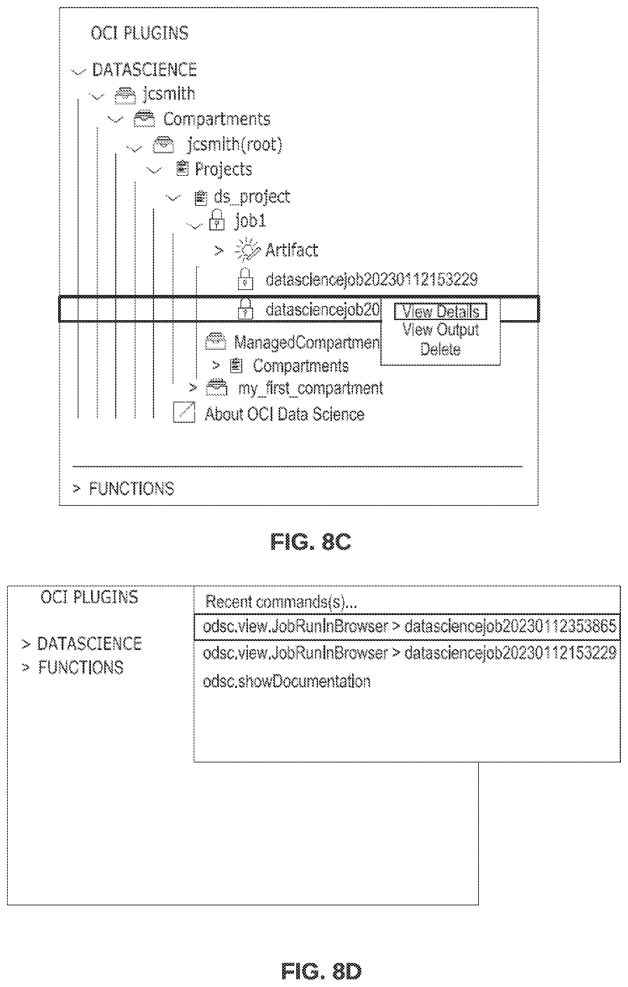

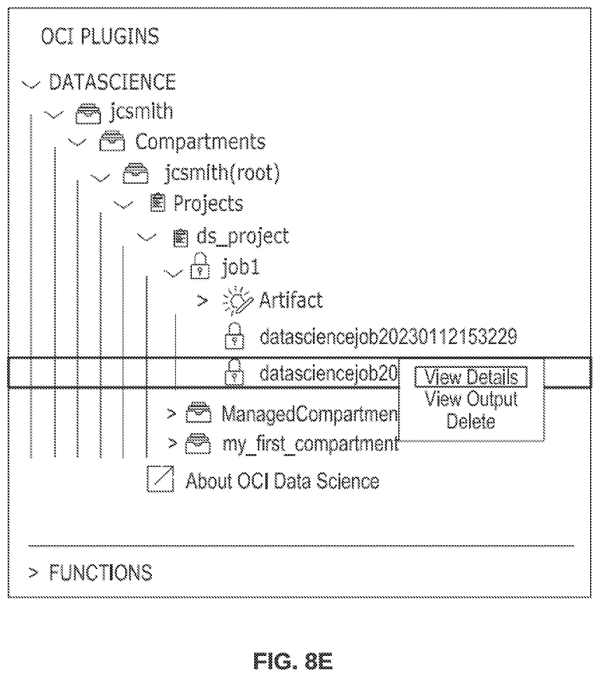

FIGS. 8A-8E illustrate operations for recording user actions along with data arguments for replay. The operations are illustrated in relation to a hierarchal tree provided in a project explorer of an integrated development environment. In the example, the hierarchal tree in the project explorer is titled “OCI PLUGINS”.

FIG. 8A illustrates a hierarchical tree in a fully collapsed state. In the collapsed state, each branch of the tree is closed, with only the highest or topmost levels of the tree, also referred to as root nodes, exposed. The root nodes include DATASCIENCE and FUNCTIONS. Indication that the root nodes are expandable is provided by the right-facing arrows preceding a label for each node.

FIG. 8B illustrates the hierarchical tree from FIG. 8A in a partially expanded state. In the partially expanded state, each of the branches or nodes of the hierarchical tree that have been expanded are indicated by a downward-facing arrow preceding each node. A terminal node or end point does not include an arrow preceding the node, and represent files, jobs, or other objects that may be acted upon. Child nodes that may be further expanded are indicated by a right-facing arrow preceding a label for each of the child nodes.

FIG. 8C illustrates an action being performed on the data object, e.g., job, identified as “datasciencejob20230112153229”. As shown, the interface element, e.g., icon representing the job, is highlighted by a user action, e.g., clicking on the icon representing the job. A subsequent user action further causes display of a menu of interface elements that correspond to actions that may be performed in relation to the job. The user action may include right-clicking on the icon representing the job. The actions provided in the menu include “View Details”, “View Output”, and “Delete”. Selection of “View Details” in the menu causes launching of a browser and details of the job to be displayed in the browser (not shown).

A control application monitors the user actions relative to the hierarchal structure. The control application intercepts the command executed in response to the selection of “View Details” and determines if a command associated with the user action meets recordation criteria. In response to determining that the action meets recordation criteria, the control application records the user action relative to the interface element and the data argument provided as input to cause execution of the command as a key value pair. The key of the key value pair is the action and the value is the job. The action is identified by a unique action ID. The readable unique action ID for the “View Details” action is “view.JobRunInBrowser”.

FIG. 8D illustrates a menu displaying recorded actions and the data arguments corresponding to the recorded actions. The menu displaying the recorded action is called using a shortcut, e.g., “cmd+L”. The menu displays the key value pairs of the most recent recorded user actions. In this example, three actions have been recorded. The recorded user action corresponding to “View Details” of “datasciencejob20230112153229” is listed first as the user action is the most recently recorded user action. The key value pair corresponding to “View Details” of “datasciencejob20230112153229” is displayed as “odsc.view.JobRunInBrowser>datasciencejob20230112153229”. Selection of this entry or shortcut in the menu of recorded actions causes replay of the user action. More particularly, selection of this entry causes the control application to submit the user action to the application GUI as if the user had performed the action.

FIG. 8E illustrates the application GUI in response to receiving the submission of the user action. As shown, the application GUI recreates the system features necessary for performing the user action. This includes expanding each of the nodes of the hierarchal tree necessary to expose the “datasciencejob20230112153229”, highlighting of “datasciencejob20230112153229”, opening the menu to display “View Details” and selecting “View Details” from the menu. In this manner, the actions that were performed originally in response to the user action are reperformed in response to selection of the recorded action simply by selecting the option from the menu of recorded actions. The user does not need to spend time expanding the nodes of the hierarchal tree or provide data arguments for executing the commands associated with the actions.

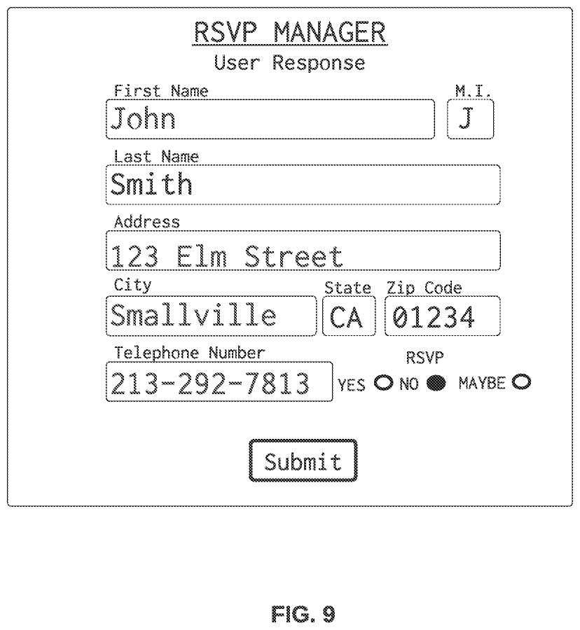

FIG. 9 illustrates an RSVP Manager for providing contact information for a user and a response to an invitation. The RSVP Manager includes a Graphical User Interface (GUI) that displays a plurality of text fields corresponding to contact information for a user. The GUI also includes radio buttons for indicating a response to an invitation. Once the contact information is entered and a response to the invitation is indicated, the user submits the response by selecting the “Submit” button. The “Submit” button may be selected by clicking on the interface element or navigating to the interface element using a keyboard and pressing the “Enter” key on the keyboard. Selecting the “Submit” button executes a command that provides the contact information and user response to the appropriate application.

When a user is responding to multiple invitations, entering the contact information and a response to each of the multiple invitations is time consuming and inefficient. Using a control application, the user action, e.g., selecting of the “Submit” button, along with the data arguments provided by the user, e.g., the contact information and user response, are recorded for future playback. In this manner, additional invitations may be responded to by using the control application to replay the recorded submission without the user having to reenter the contact information and select the radio button corresponding to a “NO” response to the RSVP selection.

In instances where the user would like to respond to an invitation with a different response, e.g., the user would like to respond to the RSVP with a “YES” or a “MAYBE”, the control application can be used to record a user action for each of the other responses. In this manner, the user would have three recorded user action to choose from when responding to additional invitations, with a first recorded user action corresponding to a “NO” response, a second recorded user action corresponding to a “YES” response, and a third recorded user action corresponding to a “MAYBE” response. In each of the first, second, and third recorded user actions, the contact information is automatically provided along with the respective response, thereby saving the user from having to re-enter their contact information each time they respond to an invitation.

### 7. Miscellaneous; Extensions

Embodiments are directed to a system with one or more devices that include a hardware processor and that are configured to perform any of the operations described herein and/or recited in any of the claims below.

Embodiments are directed to a system including means to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

All references, including publications, patent applications, and patents, cited herein are hereby incorporated by reference to the same extent as if each reference were individually and specifically indicated to be incorporated by reference and were set forth in its entirety herein.

What is claimed is:

1. One or more non-transitory computer readable media comprising instructions which, when executed by one or more hardware processors, causes performance of operations comprising:
monitoring execution of an application, the application being executed in accordance with a plurality of user actions being received by the application;
detecting a first command corresponding to submission of a user action, of the plurality of user actions, in relation to a target interface element displayed by a Graphical User Interface (GUI);
responsive to detecting the first command, recording:
(a) the user action in relation to the target interface element of the GUI; and
(b) a set of one or more data arguments selected, in response to the submission of the user action, for executing the first command,
wherein the set of one or more data arguments are recorded in association with the user action;
receiving a request to replay the submission of the user action;
responsive to receiving the request to replay the submission of the user action to the target interface element, retrieving the set of data arguments recorded in association with the user action; and
causing execution of the first command at least by submitting the user action and the set of one or more data arguments to the GUI.

2. The one or more non-transitory computer readable media of claim 1, wherein causing execution of the first command comprises:
identifying system features that enable successful execution of the first command; and
configuring the system features to enable successful execution of the first command;
wherein the user action and the set of one or more data arguments are submitted to the GUI subsequent to causing the display of the target interface element within the GUI.

3. The one or more non-transitory computer readable media of claim 1, wherein causing execution of the first command comprises:
causing display of interface elements within the GUI to enable successful execution of the first command;
wherein the user action and the set of one or more data arguments are submitted to the GUI subsequent to causing the display of the interface elements within the GUI.

4. The one or more non-transitory computer readable media of claim 3, wherein causing display of the interface elements within the GUI to enable successful execution of the first command comprises:
subsequent to receiving the request to replay the submission of the user action:
computing, a set of one or more commands that result in a display of the interface elements within the GUI; and
executing the set of one or more commands, the set of one or more commands being executed prior to submitting the user action and the set of one or more data arguments to the GUI.

5. The one or more non-transitory computer readable media of claim 1, wherein causing execution of the first command comprises:
subsequent to receiving the request to replay the submission of the user action:
computing, a set of one or more commands that are to be executed to enable successful execution of the first command; and
executing the set of one or more commands, the set of one or more commands being executed prior to submitting the user action and the set of one or more data arguments to the GUI.

6. The one or more non-transitory computer readable media of claim 1, wherein the operations further comprise:
determining whether the first command meets one or more recordation criteria;
wherein the recording operation is further responsive to determining that the first command meets the one or more recordation criteria.

7. The one or more non-transitory computer readable media of claim 6, wherein the recordation criteria defines characteristics of one or more of: the user action, the first command, or the data arguments used for execution of the first command.

8. The one or more non-transitory computer readable media of claim 6, wherein determining whether the first command meets one or more recordation criteria comprises:
identifying the first command in a list of application commands for the application.

9. The one or more non-transitory computer readable media of claim 1, wherein the operations further comprise:
displaying a replay menu comprising a set of stored user actions that may be replayed, the set of stored user actions comprising the user action;
wherein the request to replay the submission of the user action comprises selection of the user action from the replay menu.

10. The one or more non-transitory computer readable media of claim 9, wherein the set of stored user actions further comprises the set of one or more data arguments stored in association with the respective user action.

11. The one or more non-transitory computer readable media of claim 1, wherein recording the set of one or more data arguments selected, in response to the submission of the user action, for executing the first command comprises:
determining, by the GUI, the set of one or more data arguments for submission with the first command; and
recording the set of one or more data arguments, determined by the GUI, for submission with the first command.

12. The one or more non-transitory computer readable media of claim 1, wherein recording the set of one or more data arguments selected, in response to the submission of the user action, for executing the first command comprises:
determining, by the GUI, the set of one or more data arguments for submission with the first command based on user input received in relation to one or more interface elements of the GUI.

13. The one or more non-transitory computer readable media of claim 1, wherein the detecting the first command comprises intercepting transmission of the first command from the GUI to command execution module.

14. A method comprising:
monitoring execution of an application, the application being executed in accordance with a plurality of user actions being received by the application;
detecting a first command corresponding to submission of a user action, of the plurality of user actions, in relation to a target interface element displayed by a Graphical User Interface (GUI);
responsive to detecting the first command, recording:
(a) the user action in relation to the target interface element of the GUI; and
(b) a set of one or more data arguments selected, in response to the submission of the user action, for executing the first command,
wherein the set of one or more data arguments are recorded in association with the user action;
receiving a request to replay the submission of the user action;
responsive to receiving the request to replay the submission of the user action to the target interface element, retrieving the set of data arguments recorded in association with the user action; and
causing execution of the first command at least by submitting the user action and the set of one or more data arguments to the GUI.

15. The method of claim 14, wherein causing execution of the first command comprises:
identifying system features that enable successful execution of the first command; and
configuring the system features to enable successful execution of the first command;
wherein the user action and the set of one or more data arguments are submitted to the GUI subsequent to causing the display of the target interface elements within the GUI.

16. The method of claim 14, wherein causing execution of the first command comprises:
causing display of interface elements within the GUI to enable successful execution of the first command;
wherein the user action and the set of one or more data arguments are submitted to the GUI subsequent to causing the display of the interface elements within the GUI.

17. The method of claim 16, wherein causing display of the interface elements within the GUI to enable successful execution of the first command comprises:
subsequent to receiving the request to replay the submission of the user action:
computing, a set of one or more commands that result in a display of the interface elements within the GUI; and
executing the set of one or more commands, the set of one or more commands being executed prior to submitting the user action and the set of one or more data arguments to the GUI.

18. The method of claim 14, wherein causing execution of the first command comprises:
subsequent to receiving the request to replay the submission of the user action:
computing, a set of one or more commands that are to be executed to enable successful execution of the first command; and
executing the set of one or more commands, the set of one or more commands being executed prior to submitting the user action and the set of one or more data arguments to the GUI.

19. The method of claim 14, further comprising:
determining whether the first command meets one or more recordation criteria;
wherein the recording operation is further responsive to determining that the first command meets the one or more recordation criteria.

20. A system comprising:
one or more processors; and
memory storing instructions that, when executed by the one or more processors, cause the system to perform:
monitoring execution of an application, the application being executed in accordance with a plurality of user actions being received by the application;
detecting a first command corresponding to submission of a user action, of the plurality of user actions, in relation to a target interface element displayed by a Graphical User Interface (GUI);
responsive to detecting the first command, recording:
(a) the user action in relation to the target interface element of the GUI; and
(b) a set of one or more data arguments selected, in response to the submission of the user action, for executing the first command,
wherein the set of one or more data arguments are recorded in association with the user action;
receiving a request to replay the submission of the user action;
responsive to receiving the request to replay the submission of the user action to the target interface element, retrieving the set of data arguments recorded in association with the user action; and
causing execution of the first command at least by submitting the user action and the set of one or more data arguments to the GUI.
